(19) United States
(12) Patent Application Publication
(10) Pub. No.: US 2019/0014223 A1
(43) Pub. Date: Jan. 10, 2019

(54) DOCUMENT CONVEYING DEVICE AND IMAGE FORMING APPARATUS

(71) Applicant: KYOCERA Document Solutions Inc., Osaka (JP)

(72) Inventor: Masayuki KAKUTA, Osaka-shi (JP)

(73) Assignee: KYOCERA Document Solutions Inc., Osaka (JP)

(21) Appl. No.: 15/995,503

(22) Filed: Jun. 1, 2018

(30) Foreign Application Priority Data
Jul. 10, 2017 (JP) 2017-134925

(51) Int. Cl. H04N 1/00

(52) U.S. Cl. CPC H04N 1/0061; H04N 1/00615; H04N 1/00607; H04N 1/00602

(57) ABSTRACT

A document conveying device includes an inversion path, a lift member, a drive source, a conveying part, a detection part and a control part. The lift member forms an upper side face of the inversion path. The drive source moves the lift member upward and downward in the inversion path. The conveying part is pushed up by the uppermost document, and rotates to feed the uppermost document. The detection part detects a height of the conveying part. The control part executes an overload feeding mode in which whether the document is overloaded is determined based on a detection result of the detection part, when an overload is determined, the lift member is moved downward until the overload is not determined, the drive source moves the lift member upward until the conveying part is pushed up to an optimum feeding height, and then the uppermost document is fed.

### INCORPORATION BY REFERENCE

This application is based on and claims the benefit of priority from Japanese Patent application No. 2017-134925 filed on Jul. 10, 2017, which is incorporated by reference in its entirety.

### BACKGROUND

The present disclosure relates to a document conveying device conveying a document and an image forming apparatus which forms an image based on an image data of the document conveyed by the document conveying device.

An image forming apparatus is sometimes provided with a document conveying device which feeds a document placed on a placement tray and conveys the document to an image reading part where an image data of the document is read. Based on the image data read by the image reading part, the image forming apparatus forms an image on a sheet.

The document is placed on the placement tray as described above. If the document is overloaded, the feeding and separating of the document may not be performed normally. Then, the document conveying device is sometimes configured to have a countermeasure against the overload of the document. For example, the document conveying device may stop the feeding of the document when the overload of the document is detected. Alternatively, the document conveying device may have a configuration where a home position of the placement means (the placement tray) is set to upper and lower positions and moves the placement means to the lower home position when the overload is detected.

However, if the feeding of the document is stopped when the overload of the document is detected, it is required to remove the document from the placement tray and then to replace the document on the placement tray after the number of the document is reduced. Then, the user spends much time for the replacement work, and the document conveying ability is lowered. In case of the two home positions, since two detecting means for detecting the home position are required, the control of the document conveying device is complicated.

### SUMMARY

In accordance with an aspect of the present disclosure, a document conveying device includes an inversion path, a lift member, a drive source, a conveying part, a detection part and a control part. The inversion path inverts a conveying direction of a document. On the lift member, the document is placed. The lift member forms a part of an upper side face of the inversion path. The drive source moves the lift member upward and downward in the inversion path. The conveying part comes into contact with an uppermost document of the document placed on the lift member, is pushed up by the uppermost document, and rotates to feed the uppermost document. The detection part detects a height of the conveying part. The control part executes an overload feeding mode in which whether the document is overloaded or not is determined based on a detection result of the detection part, when an overload of the document is determined, the lift member is moved downward until the overload is not determined, the drive source is driven to move the lift member upward until the conveying part is pushed up to an optimum feeding height by the uppermost document, and then the uppermost document is fed.

In accordance with an aspect of the present disclosure, an image forming apparatus included an image forming part which forms an image based on an image data of a document conveyed by the document conveying device.

The above and other objects, features, and advantages of the present disclosure will become more apparent from the following description when taken in conjunction with the accompanying drawings in which a preferred embodiment of the present disclosure is shown byway of illustrative example.

### BRIEF DESCRIPTION OF THE DRAWINGS

FIG. 1 is a front view schematically showing entire structures of an image forming apparatus and a document conveying device according to one embodiment of the present disclosure.

FIG. 2 is a sectional view showing the document conveying device according to the embodiment of the present disclosure.

FIG. 3 is a sectional view showing a lift member of the document conveying device according to the embodiment of the present disclosure.

FIG. 4 is a block diagram showing a control part of the document conveying device according to the embodiment of the present disclosure.

FIG. 5 is a flowchart showing a document conveying operation in a one-side reading operation, in the document conveying device according to the embodiment of the present disclosure.

FIG. 6A is a side view showing the lift member and a feed roller before a document is placed, in the conveying device according to the embodiment of the present disclosure.

FIG. 6B is a side view showing the lift member and the feed roller when the document is overloaded, in the conveying device according to the embodiment of the present disclosure.

FIG. 6C is a side view showing the lift member and the feed roller after an overload of the document is determined, in the conveying device according to the embodiment of the present disclosure.

FIG. 6D is a side view showing the lift member and the feed roller at an optimum feeding height, in the conveying device according to the embodiment of the present disclosure.

FIG. 7 is a flowchart showing a document conveying operation in a both-side reading operation (when the document is overloaded), in the document conveying device according to the embodiment of the present disclosure.

### DETAILED DESCRIPTION

Hereinafter, with reference to the attached drawings, a document conveying device and an image forming apparatus according to one embodiment of the present disclosure will be described.

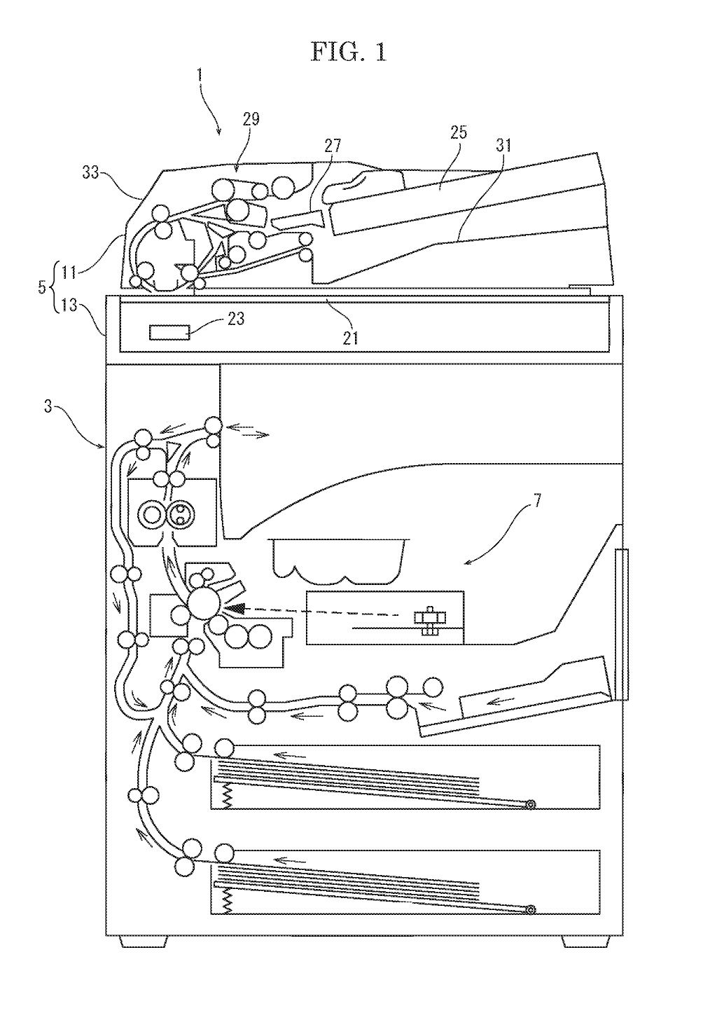

With reference to FIG. 1, an entire structure of a color printer 1 will be described. FIG. 1 is a front view schematically showing the entire structure of the color printer 1. In the following description, a near side (a front side) of a paper plan of FIG. 1 is decided to be a front side of the color printer 1. In each figure, Fr, Rr, L and R respectively indicate a front side, a rear side, a left side and a right side of the color printer 1.

As shown in FIG. 1, the color printer 1 includes an image forming apparatus 3 and a document conveying device 5 arranged above the image forming apparatus 3. The document conveying device 5 is configured to convey a document along a conveying path automatically and to read an image data of the conveyed document. The image forming apparatus 3 includes an image forming part 7 which forms an image, corresponding to the image data read by the document conveying device 5, on a sheet.

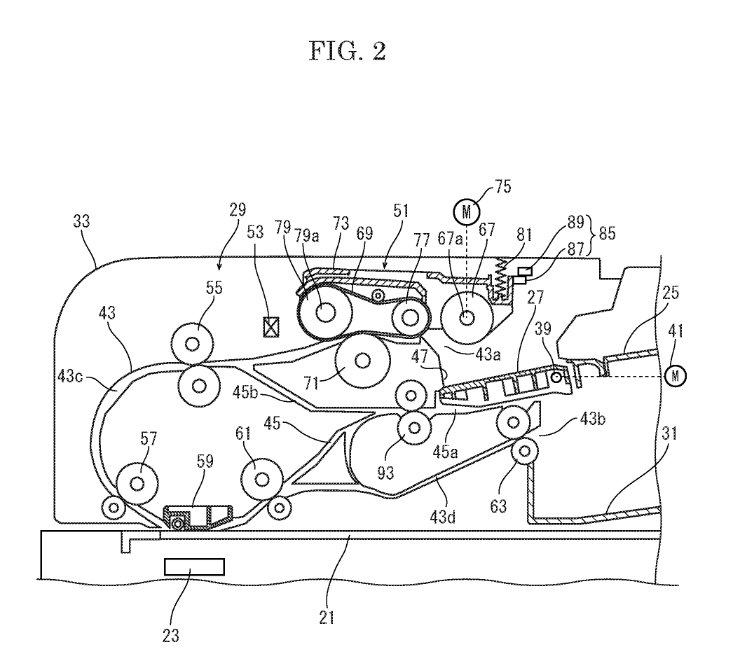

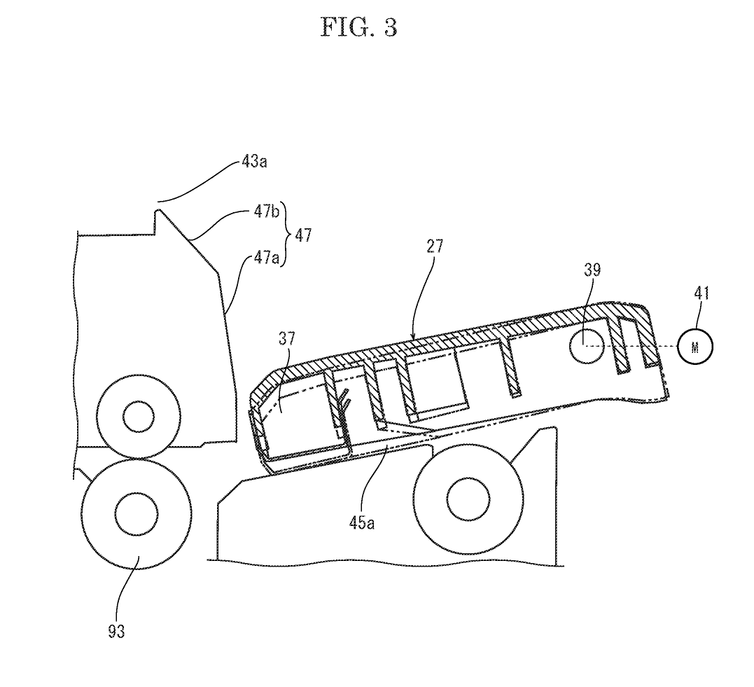

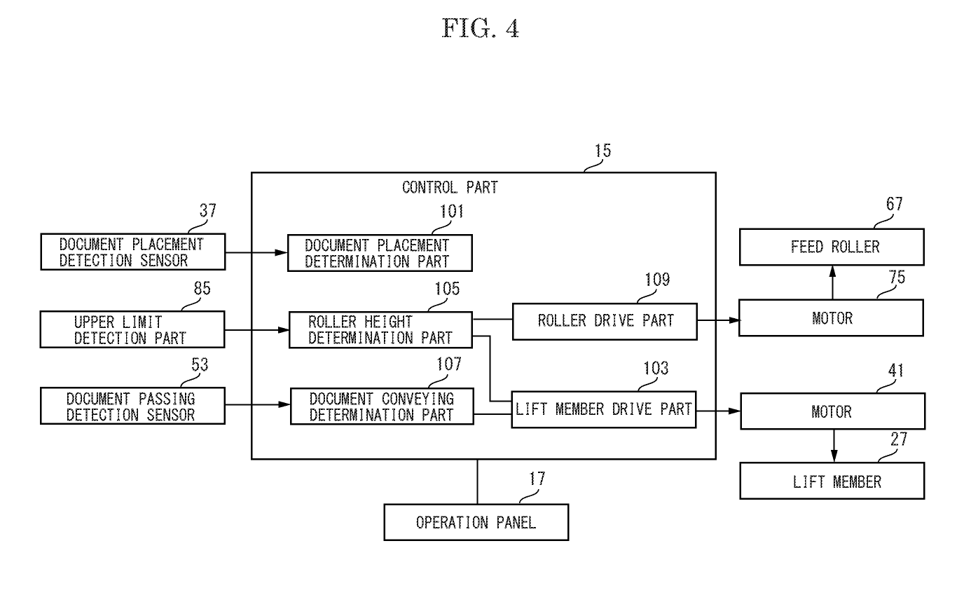

Next, with reference to FIG. 2 to FIG. 4, in addition to FIG. 1, the document conveying device 5 will be described. FIG. 2 is a sectional view showing a conveying unit, FIG. 3 is a sectional view showing a lift member and FIG. 4 is a block diagram of a control part. The document conveying device 5 is provided with a conveying unit 11 (refer to FIG. 1), a document reading unit 13 (refer to FIG. 1), a control part 15 (refer to FIG. 4) and an operation panel 17 (refer to FIG. 4). The conveying unit 11 conveys the document automatically along the conveying path. The document reading unit 13 is arranged below the conveying unit 11, and reads the image date of the document. The control part 15 controls the document conveying operation of the conveying unit 11 and the image data reading operation of the document reading unit 13. The operation panel 17 is an operation part operated by a user.

The document reading unit 13 will be described with reference to FIG. 1. The document reading unit 13 is formed in a shallow approximately rectangular parallelepiped shape capable of being placed on an upper face of the image forming apparatus 3. An upper face of the document reading unit 13 is covered with a contact glass 21. Under a left end portion of the contact glass 21, a contact type image sensor 23 reading the image data of the document is arranged along a width direction (a front-and-rear direction) perpendicular to the conveying direction of the document.

The conveying unit 11 will be described with reference to FIG. 1 and FIG. 2. The conveying unit 11 is provided with a placement tray 25, a lift member 27, a document conveying part 29 and an ejecting tray 31 which are arranged in the order along the conveying direction. They are supported by a main body 33.

The placement tray 25 is a plate-like rectangular member on which a predetermined size document is placed. On an upper face of the placement tray 25, a pair of side cursors are supported in a slidable manner in the width direction so as to align the document in the width direction. The placement tray 25 is supported by the main body 33 with an inclined posture downward along the conveying direction.

The lift member 27 is arranged at the downstream side of the placement tray 25 in the conveying direction so as to connect with the upper face of the placement tray 25. On the lift member 27, a downstream side end portion (a lead side end portion) of the document is placed. As shown in FIG. 3, the lift member 27 holds a document placement detection sensor 37. The document placement detection sensor 37 detects whether the document is placed on the lift member 27 or not. The document placement detection sensor 37 is electrically connected to the control part 15.

The lift member 27 is formed with a supporting shaft 39 at the end portion on the side of the placement tray 25, and is supported so as to be turned together with the supporting shaft 39. The supporting shaft 39 is supported by the main body 33 in a rotatable manner. To one end of the supporting shaft 39, a motor 41 rotatable normally and inversely, as a drive source which moves the lift member 27 upward and downward, is connected. When the motor 41 rotates the supporting shaft 39, the lift member 27 is turned in the upper-and-lower direction (moved upward and downward) around the supporting shaft 39. The supporting shaft 39 is rotated by the motor 41 so as to position the lift member 27 at a home position. The motor 41 is electrically connected to the control part 15.

As shown in FIG. 2, the document conveying part 29 includes a main conveying path 43 and an inversion conveying path 45 formed therein. The main conveying path 43 is formed in a laid down U-shaped curve from an inlet 43a provided at the downstream side of the lift member 27 to an outlet 43b provided below the inlet 43a. The inlet 43a is formed with a guide part 47. As shown in FIG. 3, the guide part 47 includes an abutment wall 47a slightly inclined to the downstream side with respect to the vertical face and a guide wall 47b inclined to the downstream side from an upper end of the abutment wall 47a. On the abutment wall 47a, the lead edge of the document placed on the placement tray 25 and the lift member 27 is butted. Then, an uppermost document of the placed document is fed along the guide wall 47b. This regulates a number of the document to be fed suitably.

On the main conveying path 43, a feeding part 51, a document passing detection sensor 53, a first conveying roller 55, a resist roller 57, an image reading part 59, a second conveying roller 61 and a third conveying roller 63 are provided in the order along the conveying direction.

The feeding part 51 feeds the uppermost document of the document placed on the placement tray 25 and the lift member 27 to the main conveying path 43. The feeding part 51 includes a feed roller 67, a supply belt 69, a separation roller 71 and a holder 73. The feed roller 67 is a conveying part which comes into contact with the uppermost document and then feeds the uppermost document. The supply belt 69 and the separation roller 71 forms a separation nip at which the fed document is separated. The holder 73 supports the feed roller 67 and the supply belt 69.

The feed roller 67 is supported by an upstream side end portion of the holder 73 in a rotatable manner. A rotating shaft 67a of the feed roller 67 is connected to a motor 75. When the rotating shaft 67a is rotated by the motor 75, the feed roller 67 rotates in the clockwise direction of FIG. 2. The supply belt 69 is wound around an upstream side pulley 77 and a downstream side pulley 79, at the downstream side of the feed roller 67. When a rotating shaft 79a of the downstream side pulley 79 is driven to be rotated, the supply belt 69 circulates in the clockwise direction of FIG. 2. The holder 73 is arranged above the inlet 43a of the main conveying path 43, and the feed roller 67 faces a downstream side end portion of the lift member 27 with a predetermined space. The separation roller 71 comes into contact with the supply belt 69 from the lower side between the pulleys 77 and 79. Between the separation roller 71 and the supply belt 69, the separation nip is formed.

The holder 73 is supported in a turnable manner in the upper-and-lower direction around the rotating shaft 79a of the downstream side pulley 79. The upstream side end portion of the holder 73 is biased downward by a spring 81 such that the feed roller 67 is pressed on the uppermost document of the document placed on the placement tray 25 and the lift member 27. On the other hand, when the feed roller 67 is pushed up by the document from the lower side, the holder 73 is turned upward around the rotating shaft 79a against the biasing force of the spring 81.

The height of the holder 73 is detected by an upper limit detection part 85 as a detection part which detects the feed roller 67 turned to an optimum feeding height. At the optimum feeding height, the feed roller 67 can feed the uppermost document of the document placed on the placement tray 25 and the lift member 27 suitably along the guide wall 47b of the guide part 47. When the document is fed and a number of the placed document is reduced, the holder 73 is turned as described above, and the height of the feed roller 67 is varied. That is, a contact position between the feed roller 67 and the uppermost document is varied. Then, it may be difficult to feed the uppermost document suitably along the guide wall 47b. Therefore, by rotating the supporting shaft 39 of the lift member 27 until the upper limit detection part 85 detects the holder 73, it becomes possible to keep the feed roller 67 at the optimum feeding height.

The upper limit detection part 85 includes a protruding piece 87 provided at the upstream side end portion of the holder 73 and an optical sensor 89 provided at the main body 33. The optical sensor 89 includes a light emitting part and a light receiving part which face each other with a predetermined interval, and between the light emitting part and the light receiving part, a light path is formed. When the light path is closed, the optical sensor 89 is switched from off to on and then outputs a signal. The optical sensor 89 is positioned to the main body 33 such that the protruding piece 87 of the holder 73 turned to the optimum feeding height is inserted between the light emitting part and the light receiving part, that is, the protruding piece 87 closes the light path. The optical sensor 89 is electrically connected to the control part 15.

The document passing detection sensor 53 detects whether the document passes through a predetermined position on the main conveying path 43. The document passing detection sensor 53 is electrically connected to the control part 15.

The image reading part 59 is arranged so as to face the contact type image sensor 23 of the document reading unit 13 via the contact glass 21. The document is conveyed to the image reading part 59 after the conveying timing is controlled by the resist roller 57, and the image data of the document is read by the contact type image sensor 23.

The first conveying roller 55 is arranged between the document passing detection sensor 53 and the resist roller 57. The second conveying roller 61 is arranged at the downstream side of the image reading part 59. The third conveying roller 63 is arranged at the outlet 43b.

Here, the main conveying path 43 contains a first conveying path 43c from the inlet 43a to the second conveying roller 61 and a second conveying path 43d from the second conveying roller 61 to the outlet 43b.

Next, the inversion conveying path 45 will be described. The inversion conveying path 45 contains a third conveying path 45a inverting the conveying direction of the document and a fourth conveying path 45b joining the document to the main conveying path 43 after the conveying direction of the document is inverted. The third conveying path 45a is branched upward from the second conveying path 43d at the downstream side of the second conveying roller 61, and extends below the lift member 27 and then to a portion above the outlet 43b of the main conveying path 43. That is, a lower face of the lift member 27 forms a part of an upper side face of the third conveying path 45a. On the third conveying path 45a, an inversion roller 93 inverting the conveying direction of the document is provided. The fourth conveying path 45b is branched from the third conveying path 45a at the upstream side of the inversion roller 93 and is joined to the main conveying path 43 between the document passing detection sensor 53 and the first conveying roller 55.

As shown in FIG. 3, when the lift member 27 is turned to the home position, the third conveying path 45a is formed below the lower face of the lift member 27. On the other hand, when the lift member 27 is turned downward lower than the home position (refer to a two-dotted line in FIG. 3), the third conveying path 45a is closed with the lift member 27.

With reference to FIG. 1 and FIG. 2, the ejecting tray 31 is formed below the placement tray 25, and is inclined upward from a portion below the outlet 43b of the main conveying path 43 toward the downstream side along the conveying direction.

Document conveying operations at a one-side reading and a both-side reading will be described with reference to FIG. 2. At the one-side reading, the document is conveyed along the main conveying path 43, and ejected on the ejecting tray 31 after the image data of the document is read at the image reading part 59. At the both-side reading, the document is conveyed along the first conveying path 43c, and then along the third conveying path 45a after the image date of one face of the document is read at the image reading part 59. Then, after the conveying direction of the document is inverted by the inversion roller 93 on the third conveying path 45a, the document is conveyed along the fourth conveying path 45b and then first conveying path 43c. At this time, the front side face and the back side of the document is inverted. Then, the document is conveyed along the first conveying path 43c, and after the image data of the other face of the document is read at the image reading part 59, the document is conveyed along the second conveying path 43d and then ejected on the ejecting tray 31.

Next, the control part 15 will be described with reference to a block diagram shown in FIG. 4. The control part 15 includes a document placement determination part 101, a lift member drive part 103, a roller height determination part 105, a document conveying determination part 107 and a roller drive part 109.

To the document placement determination part 101, the signal output from the document placement detection sensor 37 is input. Based on the output signal, the document placement determination part 101 determines whether the document is placed on the lift member 27 or not.

The lift member drive part 103 controls the drive of the motor 41 which rotates the supporting shaft 39 of the lift member 27.

To the roller height determination part 105, the signal output from the optical sensor 89 of the upper limit detection part 85 is input. Based on the output signal, the roller height determination part 105 determines whether the feed roller 67 turns to the optimum feeding height or not. In the other words, when the output signal is input, it is also determined that the feed roller 67, that is, the holder 73 turns upward.

To the document conveying determination part 107, the signal output from the document passing detection sensor 53 is input. Based on the output signal, the document conveying determination part 107 determines whether the document passes through a predetermined position (a position where the document passing detection sensor 53 is arranged) or not.

The roller drive part 109 controls the drive of the motor 75 which rotates the feed roller 67.

The operation panel 17 is a touch panel, for example. The operation panel 17 makes it possible to select various conditions regarding the document conveying operation by the user.

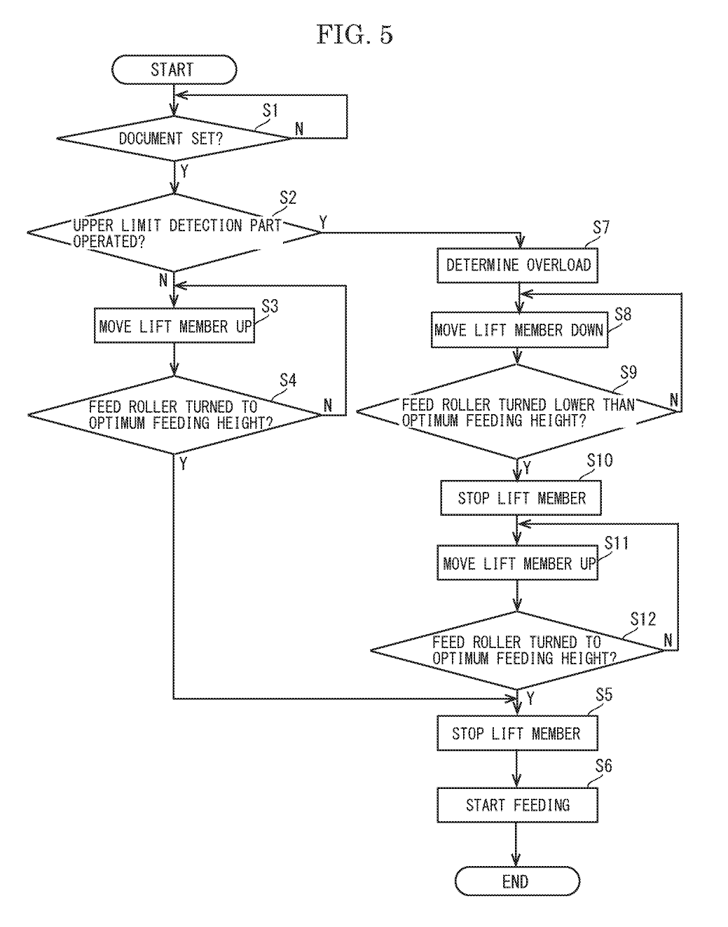

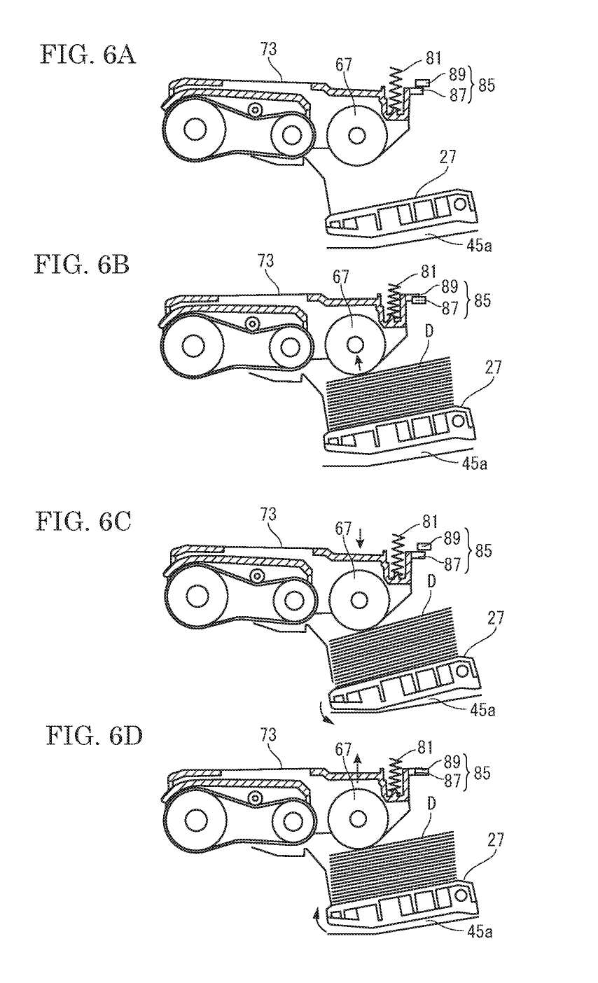

In the document conveying device 5 having the above described configuration, the document conveying operation at the one-side reading will be described with reference to the flowchart 5 shown in FIG. 5 and FIG. 6A to FIG. 6D. FIG. 6A to FIG. 6D are side views showing the lift member and the feed roller when the overload is determined.

The document conveying device 5 at an initial state will be described. As shown in FIG. 6A, at the initial state, the lift member 27 is turned to the home position. That is, the third conveying path 45a is opened, and the lift member 27 is inclined downward so as to connect with the placement tray 25. The holder 73 is biased by the spring 81, and is turned downward.

First, the user places a bundle of the documents D on the placement tray 25 and the lift member 27 through the space between the feed roller 67 and the lift member 27. The bundle of the documents D is placed such that the lead edges of the documents are butted on the abutment wall 47a. Then, at step S1, the document placement determination part 101 determines that the bundle of the documents D is placed on the lift member 27, and then it proceeds to step S2.

At step S2, the roller height determination part 105 determines whether the upper limit detection part 85 is operated or not (whether the upper limit detection part 85 outputs the signal or not). When the roller height determination part 105 determines that the upper limit detection part 85 is not operated, it proceeds to step S3. The case where the upper limit detection part 85 is not operated shows a case where the feed roller 67 is not pushed up higher than the optimum feeding height by the placed bundle of the documents D, for example, a case where a thickness of the bundle of the documents D is thinner than the space between the lift member 27 and the feed roller 67. In this case, it is determined that the bundle of the documents D is not overloaded.

Then, at step S3, the lift member drive part 103 drives the motor 41 to turn the lift member 27 upward. Thereby, the feed roller 67 is pushed up by the uppermost document. Then, at step S4, when the roller height determination part 105 determines that the feed roller 67 is turned to the optimum feeding height, it proceeds to step S5. At step S5, the lift member drive part 103 stops the drive of the motor 41. Thereby, the feed roller 67 turns to the optimum feeding height. Then, it proceeds to step S6. At step S6, the roller drive part 109 drives the motor 75 to rotate the feed roller 67. As a result, the uppermost document is fed to the main conveying path 43.

On the other hand, at step S2, when the roller height determination part 105 determines that the upper limit detection part 85 is operated, it proceeds to step S7. At step S7, the roller height determination part 105 determines that the placed bundle of the documents D is overloaded. That is, if the thickness of the bundle of the documents D is thicker than the space between the feed roller 67 and the lift member 27 at the initial state, when the bundle of the documents D is placed, as shown in FIG. 6B, the feed roller 67 is pushed up by the uppermost document, and the holder 73 is turned upward against the biasing force of the spring 81. As a result, the protruding piece 87 of the holder 73 moves upward across the light path of the optical sensor 89, the optical sensor 89 is switched from off to on and then outputs the signal. Then, the roller height determination part 105 determines that the bundle of the documents D is overloaded.

When the overload is determined at step S7, it proceeds to step S8. At step S8, the lift member drive part 103 drives the motor 41 to turn the lift member 27 downward. When the lift member 27 is turned downward, the holder 73 pushed up by the bundle of the documents D begins to turn downward by its own weight and the biasing force of the spring 81. At this time, as shown in FIG. 6C, the lift member 27 may be turned downward over the home position so as to close the third conveying path 45a. That is, because the document is not conveyed along the third conveying path 45a at the one-side reading, if the third conveying path 45a maybe closed, any problem is not caused.

Then, at step S9, the feed roller height determination part 105 determines whether the holder 73 is turned until the feed roller 67 is positioned lower than the optimum feeding height. When, at step S9, it is determined that the holder 73 is turned until the feed roller 67 is positioned lower than the optimum feeding height, it proceeds to step S10. At step 10, the lift member drive part 103 stops the drive of the motor 41, and then it proceeds to step S11.

At step S11, the lift member drive part 103 drives the motor 41 to turn the lift member 27 upward again. Then, at step S12, the roller height determination part 105 determines whether the holder 73 is turned until the feed roller 67 is pushed up by the uppermost document and positioned at the optimum feeding height. At step S12, when it is determined that the holder 73 is turned until the feed roller 67 is positioned at the optimum feeding height (refer to FIG. 6D), it proceeds to step S5. At step S5, the lift member drive part 103 stops the drive of the motor 41, and then it proceeds to step S6. At step S6, the roller drive part 109 drives the motor 75 to rotate the feed roller 67. Thereby, the uppermost document is fed to the main conveying path 43. At this time, the lift member 27 is not necessarily turned to the home position, and may close a part of the third conveying path 45a.

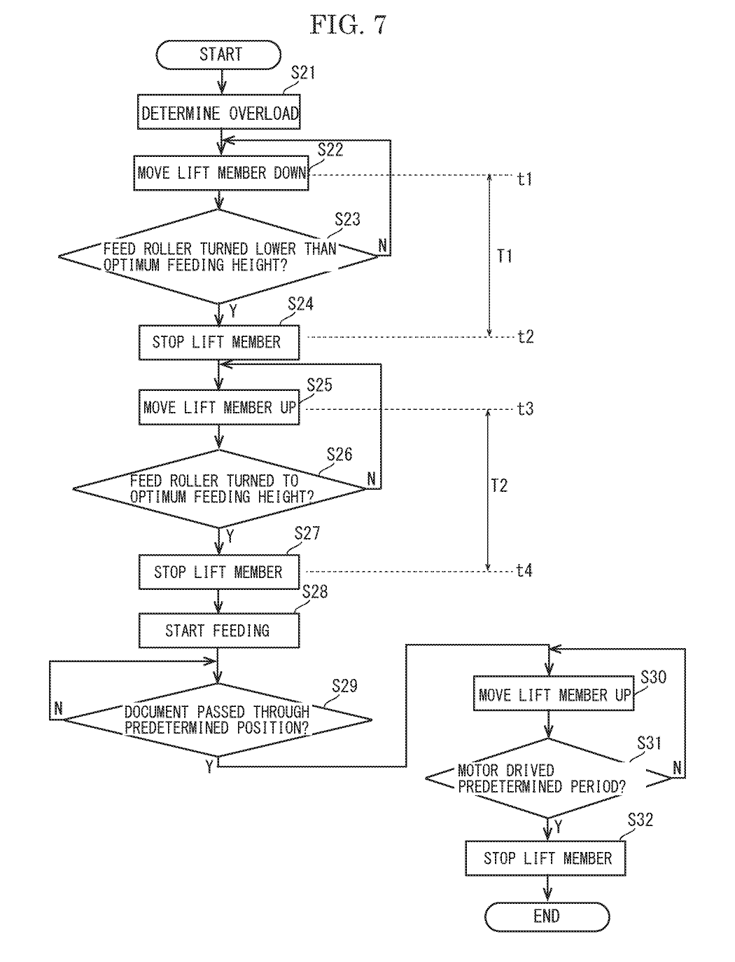

Next, the document conveying operation in the both-side reading when the overload is determined will be described with reference to a flowchart shown in FIG. 7.

Steps from S21 to S28 are the same as the steps of S7, S8, S9, S10, S11, S5 and S6, and their explanations are omitted. In the both-side reading, after the uppermost document is fed at step S28, it proceeds to step S29. At step S29, the document conveying determination part 107 determines whether the uppermost document passes through the predetermined position or not. When the document conveying determination part 107 determines that the uppermost document passes through the predetermined position, it proceeds to step S30. The predetermined position shows any positions at the upstream side of a position where the uppermost document reaches the third conveying path 45a. For example, the predetermined position may be a position where the document passing detection sensor 53 detects the uppermost document.

At step S30, the lift member drive part 103 drives the motor 41 to turn the lift member 27 upward. The lift member 27 is turned downward and then upward. However, when the lift member 27 is turned upward again at step S30, the lift member 27 may not be turned until the third conveying path 45a is fully opened, depending on the thickness of the bundle of documents D. In the both-side reading, because the document is conveyed along the third conveying path 45a, if the third conveying path 45a is closed by the lift member 27, a conveying failure of the document may occur. Thereby, at step S30, the lift member drive part 103 drives the motor 41 to turn the lift member 27 upward to open the third conveying path 45a.

Then, at step S31, the lift member drive part 103 determines whether the motor 41 is driven for a predetermined period in a predetermined direction. The predetermined period shows a difference between a period T1 and a period T2, for example, in which the period T1 is a period from a time t1 at which the motor 41 is driven to turn the lift member 27 downward from the home position at step S22 to a time t2 at which the drive of the motor 41 is stopped at step S24 and the period T2 is a period from a time t3 at which the motor 41 is driven to turn the lift member 27 upward at step S25 to a time t4 at which the drive of the motor 41 is stopped at step S27. Thereby, the lift member 27 turns to the home position, and the third conveying path 45a is suitably opened.

When it is determined that the lift member drive part 103 drives the motor 41 for the predetermined period at step S31, it proceeds to step S32. At step S32, the lift member drive part 103 stops the drive of the motor 41. Thereby, after an image data of one face of the uppermost document is read at the image reading part 59, the uppermost document is inverted through the third conveying path 45a which is suitable opened, and then an image data of the other face of the uppermost document is read at the image reading part 59.

The document conveying operation described above is defined as an overload feeding mode. After the uppermost document is conveyed as described above, a conveying of a next document begins.

As described above, in the document conveying device 5 of the present disclosure, if the document is overloaded, the lift member 27 turns to close the third conveying path 45a once so that it becomes possible to convey the document without replacing the bundle of the documents and then to read the image data of the one face and the other face of the document. In addition, because the third conveying path 45a is used as a space in which the lift member 27 is turned, it becomes possible to lower the height of the document conveying device 5.

However, in the overload feeding mode, because the conveying of a second document begins after the conveying of a first document is finished, productivity of the conveying operation may be deteriorated. Then, if the overload is determined, the user may select whether the above overload feeding mode is executed or not. For example, the operation panel 17 is configured to include a display part displaying that the document is overloaded and a run button executing the overload feeding mode. When the display part displays that the document is overloaded and then the user operates the run button, the overload feeding mode is executed. On the other hand, when the overload feeding mode is not executed, the display part shows a message to remove the bundle of the documents and then to replace the bundle after the number of the documents is reduced.

In another embodiment, the home position of the lift member 27 may be detected by a lower limit detection part. The lower limit detection part includes a protruding piece provided at the downstream side end portion of the lift member 27 and an optical sensor provided at the main body, for example. The optical sensor includes a light emitting part and a light receiving part which face each other with a predetermined interval, and between the light emitting part and the light receiving part, a light path is formed. When the light path is closed, the optical sensor is switched from off to on, and outputs a signal. The optical sensor is positioned to the main body 33 such that the protruding piece of the lift member 27 turned to the home position is inserted between the light emitting part and the light receiving part, that is, the protruding piece closes the light path. By combining the output signal of the optical sensor of the lower limit detection part and the output signal of the optical sensor 89 of the upper limit detection sensor 85, it can be determined whether the lift member 27 is turned lower or higher than the home position.

When the above lower limit detection part is provided, at step S7 in the flowchart of FIG. 7, when the lower limit detection part determines that the lift member 27 is turned to the home position, it proceeds to step S32. At step S32, the turning of the lift member 27 is stopped.

While the above description has been described with reference to the particular illustrative embodiments of the image forming apparatus according to the present disclosure, a technical range of the disclosure is not to be restricted by the description and illustration of the embodiment.

1. A document conveying device comprising:
an inversion path inverting a conveying direction of a document;
a lift member on which the document is placed, the lift member forming a part of an upper side face of the inversion path;
a drive source moving the lift member upward and downward in the inversion path;
a conveying part coming into contact with an uppermost document of the document placed on the lift member, being pushed up by the uppermost document, and rotating to feed the uppermost document;
a detection part detecting a height of the conveying part; and
a control part executing an overload feeding mode in which whether the document is overloaded or not is determined based on a detection result of the detection part, when an overload of the document is determined, the lift member is moved downward until the overload is not determined, the drive source is driven to move the lift member upward until the conveying part is pushed up to an optimum feeding height by the uppermost document, and then the uppermost document is fed
wherein when the overload of the document is determined based on the detection result of the detecting part, the control part decreases a rotating period of the conveying part.

2. The document conveying device according to claim 1,
wherein the control part moves the lift member downward in the inversion path when the overload is determined.

3. The document conveying device according to claim 1,
wherein when the overload feeding mode is executed, the control part drives the drive source to move the lift member upward after the uppermost document is fed, opens the inversion path and then feeds a next document after the uppermost document is passed through the opened inversion path.

4. The document conveying device according to claim 3,
wherein the control part moves the lift member upward and opens the inversion path by a difference between a downward moving period of the lift member until the overload is not determined and an upward moving period of the lift member until the conveying part is pushed up to the optimum feeding height.

5. The document conveying device according to claim 3, comprising an operation part where a user selects whether the overload feeding mode is executed or not.

6. The document conveying device according to claim 1, further comprising an information part;
wherein when, based on the detection result of the detection part, it is determined that an overloaded amount is larger than a certain level, the control part stops a drive of the drive source and then informs that the overloaded amount excesses the certain level, by the information part.

7. The document conveying device according to claim 6,
wherein the control part executes the overload feeding mode after the control part informs that the overloaded amount excesses the certain level.

8. The document conveying device according to claim 1,
wherein the control part stores an overloaded amount at a time when the overload feeding mode is executed, determines whether the overload feeding mode is executed in the past for an overloaded amount currently obtained by the detection result of the detection part, and then executes the overload feeding mode when it is determined that the overload feeding mode is executed in the past for the currently obtained overloaded amount.

9. (canceled)

10. An image forming apparatus comprising an image forming part which forms an image based on an image data of a document conveyed by the document conveying device according to claim 1.
